(19) United States
(12) Patent Application Publication
(10) Pub. No.: US 2008/0158164 A1
(43) Pub. Date: Jul. 3, 2008

(54) PORTABLE MEDIA STORAGE AND PLAYBACK DEVICE

(75) Inventor: Pang Lee, Hong Kong (CN)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Franklin Electronic Publishers, Inc.

(21) Appl. No.: 11/616,475

(22) Filed: Dec. 27, 2006

(51) Int. Cl. G06F 3/041

(52) U.S. Cl. 345/173

(57) ABSTRACT

A portable media storage/playback device (“PMSPD”) is disclosed comprising a body, a screen, a horizontal touchpad, and a vertical touchpad. The PMSPD may also include test preparation software, soft-keys, a dictionary, a smart algorithm, a headphone jack, speakers, an encyclopedia, a program for playing audio files, a program for viewing picture files, a camera, a program for recognizing words in a picture, a communication interface, and/or a wireless communication device. The PMSPD may also be limited in size to increase portability while maintaining usability.

### I. BACKGROUND OF THE INVENTION

A. Field of the Invention

This invention relates to a portable media storage/playback device for running various electronic programs, including, but not limited to, testing preparation programs.

B. Description of the Related Art

In today's constantly mobile world, people are looking for increasingly smaller devices to perform tasks previously performed on bulkier devices. One such device which has been particularly affected by this trend is the portable media storage/playback device (“PMSPD”). These PMSPDs began as MP3 players and PDAs. PDAs were multi functional and stored a variety of useful programs (e.g., address book, e-mail program, notebook, video games, etc.). On the other hand, MP3 players served only one function, the storage and playback of audio files. However, PDAs were, and remain, larger in size and more cumbersome than MP3 players. As a result, it has become advantageous to design a PMSPD that has the size benefit of an MP3 player and the multifunctional benefit of a PDA.

Initially, there were two types of MP3 players: (1) MP3 players that used flash memory to store data; (2) MP3 players that used a hard drive to store data.

The initial advantage of the flash memory MP3 players was in their size. They could be made quite small because memory they used (flash) is small. However, initially, flash memory MP3 players were limited in storage capacity due, in part, to flash memory's increasing expensiveness as storage capacity increased.

On the other hand, hard drive MP3 players have a much larger storage capacity than their flash memory counterparts. This is also as a direct result of the type of memory used: a hard drive. Hard drives are far less expensive per amount of memory than flash. However, hard drives are also bulkier than flash. As a result, the hard drive MP3 players were initially much larger in size than their flash counterparts.

As technology has advanced, the hard drives used in MP3 players have been able to be offered with increased storage capacity without greatly affecting size or price and the flash drives used have become less expensive. Eventually, it became desirable to store additional types of media on PMSPDs. As a result, PMSPDs were able to store and display digital photographs and video files.

While the desirability for a small, multifunctional PMSPD was a driving force in the evolution of such devices, another driving force was the desire to make such devices as user-friendly as possible. Some PMSPDs have a horizontal line of buttons below the screen to access the menu and play audio files. Below this line of buttons was a rotating scroll wheel for navigating the menus and lists of audio files. Other models have different designs. The rotating scroll wheel was replaced with touch-sensitive, non-moving scroll wheel, and the buttons were incorporated at different locations on the touch-sensitive scroll wheel rather than in a horizontal line separate and distinct from the scroll wheel.

### II. SUMMARY OF THE INVENTION

The current invention involves a PMSPD which incorporates a user-interface designed to simplify the use of electronic test preparation programs. The PMSPD may be modified so that a variety of electronic media and programs may be stored and run on it. The PMSPD may also be modified to be various sizes.

The administration of standardized tests has become a mainstay of the modern American educational system. Children begin taking these tests early on in grade school and continue to take them thru high school and, in some instances, beyond. Examples of these standardized tests include the ITBS (Iowa Test of Basic Skills), HSPT (High School Proficiency Test), PSAT, SAT, and ACT. The full list of standardized tests, however, is far more comprehensive.

Much importance can be given to the scores achieved on these tests. As a result, there is a need for increasingly advanced methods of preparing for such tests. The current invention relates to a PMSPD that has been particularly designed to assist in studying and preparing for standardized tests.

One way to prepare for a standardized test is to answer practice questions which simulate the types of questions administered in a particular test. Another way to prepare for a standardized test is to take practice exams. A practice exam is a set of questions which, together, simulate one or more particular test(s). The practice exam may be timed or un-timed. These are only two possible ways of preparing for a standardized test. The current invention is not limited to the two types of test preparation described above. Other types of standardized test preparation are well known in the art.

Furthermore, as a result of the desirability of multifunctional PMSPDs, the current invention may or may not include additional programs and features. These programs and features include, but are not limited to, a dictionary, an encyclopedia, the ability to play MP3s and other audio files, the ability to store and view digital photos, a camera, the ability to look up words in a dictionary based on a photograph of text, the ability to link directly to computer, and wireless capabilities.

### III. BRIEF DESCRIPTION OF THE DRAWINGS

The accompanying drawings are included to provide a better understanding of the invention and constitute part of the specification. These drawings are in now way meant to limit the scope of the invention.

FIG. 1a shows a frontal view of an embodiment of the invention with a T-input user interface.

FIG. 1b shows a right side view of an embodiment of the invention with a T-input user interface.

FIG. 1c shows a left side view of an embodiment of the invention with a T-input user interface.

FIG. 2a-c shows a series of test question screens of an embodiment of the invention with a T-input user interface.

FIG. 3a-d shows a series of screens illustrating the use of a smart algorithm in one embodiment of the invention with a T-input user interface which includes a dictionary.

### IV. DETAILED DESCRIPTION OF THE INVENTION

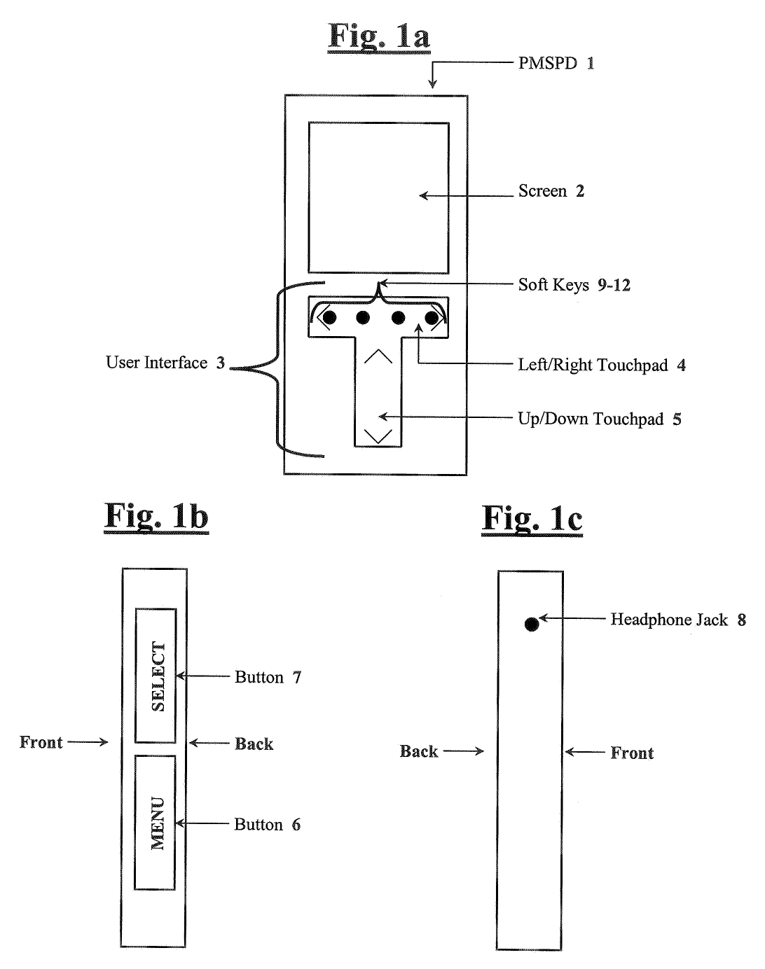

One embodiment of the current invention (FIGS. 1a-c) involves a PMSPD 1 incorporating a screen 2 on the upper portion and a user interface 3 on the lower portion. The screen 2 may be black and white or color. In this embodiment, the user interface is arranged in the shape of a T (“T-input user interface”), with the horizontal portion of the T being a left/right touchpad 4 and the vertical portion of the T being an up/down touchpad 5. This embodiment also incorporates two buttons on the side, a menu button 6 for accessing the menu and a select button 7 for making selections. Speakers (not shown) and/or a headphone jack 8 may also be incorporated in this embodiment.

A number of soft-keys 9-12 are included along the left/right touchpad 4. These soft-keys 9-12 are designed to simulate the options a test taker has when answering a question. As a result, there can be as many, or as few, soft-keys on the left/right touchpad 4 as are required by a given question. Typically, this would be four soft-keys to simulate answers A-D. However, 3 soft-keys (simulating answers A-C), 5 soft-keys (simulating answers A-E), or any other number of soft-keys may be included. The inclusion of soft-keys better prepares test takers for the actual test(s) they are preparing for. This is because the soft-keys simulate the way in which a test taker would answer an actual test as opposed to scrolling thru multiple answers to select the desired answer. With soft-keys, test takers may select the desired answer directly, as they would in the actual test. While the soft-keys 9-12 are designed to simulate the options a test taker has when answering a question, they may be used for other purposes as well. One such use would be as function keys for selecting pull-down menus. Other uses for soft-keys are well known in the art.

Soft keys 9-12 are located on left/right touchpad 4 and up/down touchpad 5 is located directly below it. Both pads can be used to indicate movements in the four directions. The touchpads can be implemented in various embodiments. One embodiment has a slidable touchpad where the user is able to move his finger along the touchpad to indicate the desired direction. Another embodiment has discrete buttons located at the respective arrow positions, which need to be pressed to indicate the desired movement. The sides of the PMSPD 1 can also have buttons and/or jacks. As shown in FIGS. 1b and 1c, one side has two buttons, a select button 7 and menu button 6. The other side has a headphone jack 8.

The locations of these touchpads and buttons are situated to make it easier for the user to use the PMSPD in one hand. The touchpads on the front of the device and the buttons on the side would be easily accessible to the user's thumb if the device itself is held in the palm of the hand. The particular locations and implementations of the buttons or touchpads can be easily modified to accommodate the overall size of the product and the nature of the software functions running.

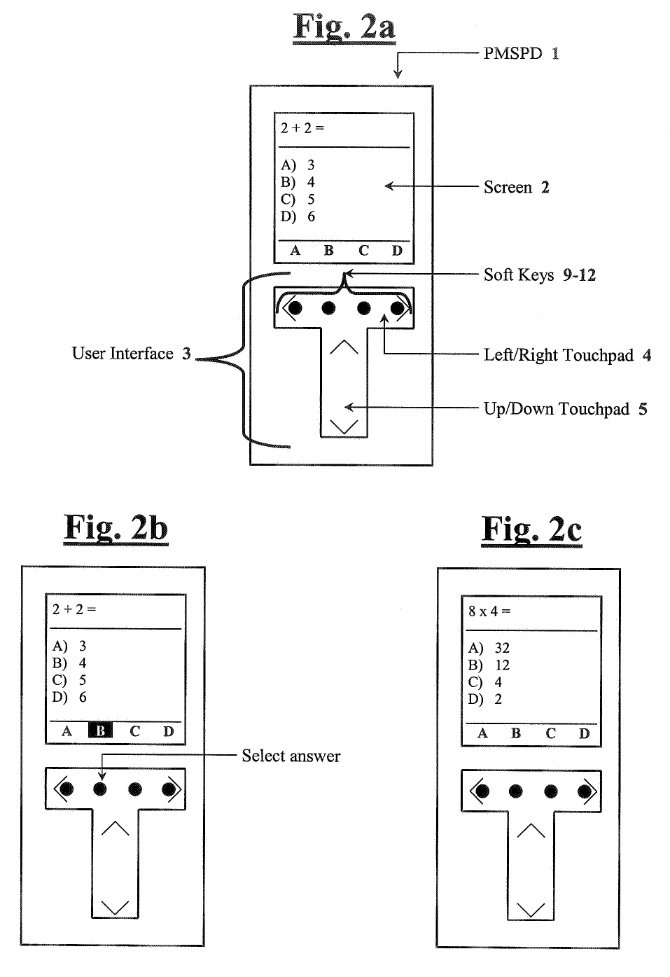

The PMSPD can have many different uses and would have the appropriate software running to implement each use. One embodiment incorporates test preparation software with a PMSPD having the above user interface (FIGS. 2a-c). This software includes practice questions and/or one or more practice exams. To take a practice exam, a test taker selects the appropriate practice exam to be taken. The practice exam then begins, and a practice question appears on the screen 2 (FIG. 2a). The test taker then proceeds thru the exam by answering the questions using the appropriate soft-keys (FIG. 2b). Once a question is answered, a new question appears on the screen 2 (FIG. 2c).

Once the exam is complete, the test taker is given a tally of his answers indicating those answered correctly, those answered incorrectly, and the total number of questions. This embodiment may also, at this point, include the option to review those questions answered incorrectly. This review may incorporate viewing the question with both the correct answer indicated as well as the incorrect answer originally selected by the test taker. Other review options may also be available.

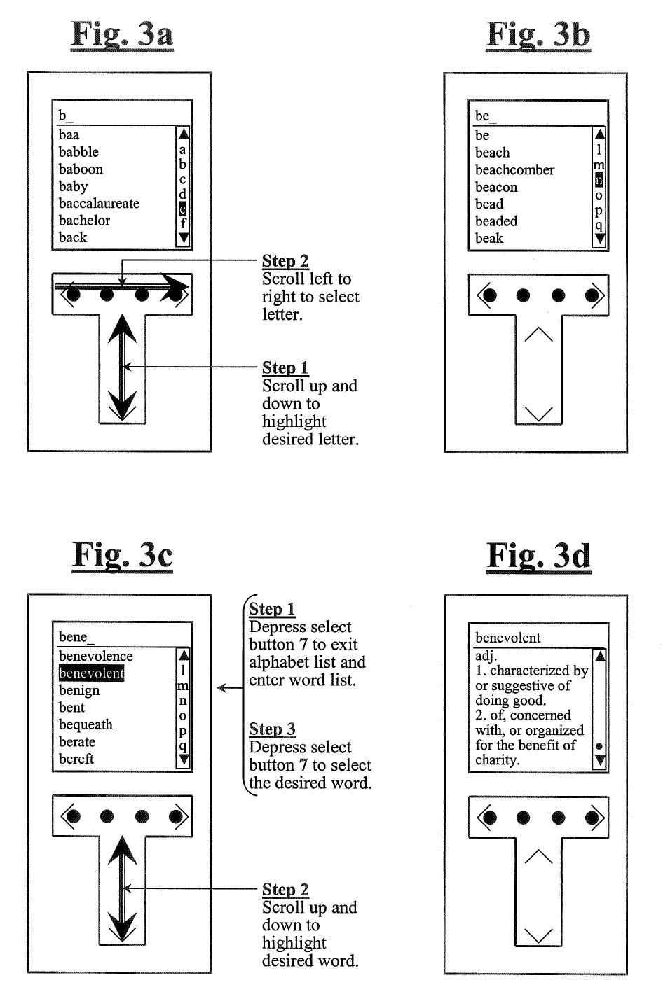

In another embodiment a dictionary is incorporated in a PMSPD having the above user interface. The navigation of this dictionary may include the use of a smart algorithm (FIGS. 3a-d). To find a definition for a particular word using this smart algorithm, a user scrolls thru a list of each letter in the alphabet. The first letter of the particular word is then selected and that letter appears in the word entry portion of the screen. An alphabetical list of all words starting with that letter then appears on the screen below the word entry portion (FIG. 3a). If the particular word appears on the screen at this point, the user then scrolls down and selects that word. The definition for that particular word then appears on the screen.

Should the particular word not appear on the screen after the first letter is selected, the second letter of the particular work is then selected in the same manner as the first letter (FIGS. 3a-b). At this point, the list of words appearing below the word entry portion of the screen then changes to an alphabetical list of all words starting with the first two selected letters (FIG. 3b). If the particular word still does not appear on the screen, this process is repeated until it does. Once the particular word appears on the screen, the user scrolls down, selects that word, and the definition for that particular word then appears on the screen (FIGS. 3c-d).

In another embodiment an encyclopedia is incorporated in a PMSPD having the above user interface. As with the dictionary, the navigation of this encyclopedia may include the use of a smart algorithm. One difference being that an encyclopedia entry, rather than a dictionary definition, appears on the screen once you select the particular term.

In yet another embodiment, a program for playing audio files is incorporated in a PMSPD having the above user interface. A particular audio file may then be played back via a number of methods. These methods include, but are not limited to, speakers built into the PMSPD, headphones attached to the PMSPD via a headphone jack 8, a computer attached to the PMSPD via a direct connection, and wireless transmission on a designated radio frequency that can be picked up on a stereo receiver or other similar equipment.

In yet another embodiment, a program for viewing picture files is incorporated in a PMSPD having the above user interface and the screen 2 is a color screen.

In yet another embodiment, a digital camera is incorporated in a PMSPD having the above user interface.

In yet another embodiment, a program for recognizing words in a picture is incorporated in a PMSPD having the above user interface and a dictionary and/or language translator. [Should we include encyclopedia usage?] A user can then scroll thru words that appear in a picture and select a word from which a dictionary definition and/or translation is desired. Once the word is selected, a dictionary definition and/or translation for that word appears on the screen. One example of such a program is Franklin®'s Smart Check.

In such an embodiment in which a digital camera has been incorporated, a user may take a picture of text containing one or more particular word(s), the definition(s) and/or translation(s) for which is desired. The word recognition program then processes the picture, identifying all words therein as well as those words' individual characters. The user may then select the particular word(s) and their definition(s) and/or translation(s) will appear on the screen.

In yet another embodiment, a communication interface for directly connecting the PMSPD to one or more computer(s) is incorporated in a PMSPD having the above user interface. Such communication interfaces are well known in the art and include, but are not limited to, USB, FireWire, IEEE-1394, and serial interfaces.

In yet another embodiment, a wireless communication device for communicating with the internet and/or one or more computer(s) wirelessly is incorporated in a PMSPD having the above user interface. Such wireless communication devices are well known in the art and include, but are not limited to, Wi-Fi and Bluetooth.

In another embodiment, the size of a PMSPD having the above user interface is limited. Preferably, the length is not more than 105 mm, the width not more than 61 mm, and the depth not more than 20 mm. More preferably, the length is not more than 90 mm, the width not more than 43 mm, and the depth not more than 15 mm. Even more preferably, the length is not more than 84 mm, the width not more than 40 mm, and the depth not more than 7 mm. While portability is a desired attribute of the current invention, it is also desired to make the PMSPD as user friendly as possible. Therefore, its size cannot be made too small, for the device must have enough room for a usable screen and user interface. If the device is made too small, either the screen or the user interface, or both, will be too small to be used comfortably.

None of the above embodiments is meant to limit the current invention. In addition, the features of any of the above embodiments may be incorporated individually, or in combination, in the present invention.

What is claimed is:

1. A portable media storage/playback device (“PMSPD”) comprising: (screen and T-Input) a body;
a screen;
a horizontal touchpad; and
a vertical touchpad.

2. The PMSPD of claim 1, further comprising:
one or more buttons, the buttons being located below the screen in a horizontal configuration.

3. The PMSPD of claim 1, further comprising:
one or more buttons, each of which corresponds with no more than one answer for each question contained in test preparation software.

4. The PMSPD of claim 3, wherein the one or more buttons are soft-keys.

5. The PMSPD of claim 4, wherein any of the soft-keys are located on the horizontal touchpad.

6. The PMSPD of claim 4, wherein all of the soft-keys are located on the horizontal touchpad.

7. The PMSPD of claim 4, wherein any of the soft-keys are located on the vertical touchpad.

8. The PMSPD of claim 4, wherein all of the soft-keys are located on the vertical touchpad.

9. The PMSPD of claim 4, wherein the soft-keys are located on both the horizontal touchpad and the vertical touchpad.

10. The PMSPD of claim 4, wherein all the soft-keys are located on either the horizontal touchpad or the vertical touchpad.

11. The PMSPD of claim 1, further comprising:
test preparation software.

12. The PMSPD of claim 3, further comprising:
test preparation software.

13. The PMSPD of claim 11, wherein the test preparation software includes practice questions.

14. The PMSPD of claim 11, wherein the test preparation software includes practice tests.

15. The PMSPD of claim 13, wherein the test preparation software includes an ability to review practice questions already taken.

16. The PMSPD of claim 15, wherein, in the review, both the correct answer and the answer originally selected are indicated for each question answered incorrectly.

17. The PMSPD of claim 11, wherein the test preparation software includes an ability to review practice tests already taken.

18. The PMSPD of claim 17, wherein, in the review, both the correct answer and the answer originally selected are indicated for each question answered incorrectly.

19. The PMSPD of claim 17, wherein the ability to review practice tests already taken includes a list containing a tally of any of: all questions in the test, all questions answered, all questions answered correctly, and all questions answered incorrectly.

20. The PMSPD of claim 1, further comprising:
a dictionary.

21. The PMSPD of claim 20, further comprising:
the use of a smart algorithm.

22. The PMSPD of claim 1, further comprising:
a headphone jack.

23. The PMSPD of claim 1, further comprising:
speakers.

24. The PMSPD of claim 22, further comprising:
speakers.

25. The PMSPD of claim 1, further comprising:
one or more of a list of an encyclopedia, a language translator, a program for playing audio files, a program for viewing picture files, a camera, a program for recognizing words in a picture, a communication interface, a wireless communication device.

26. The PMSPD of claim 25 which includes an encyclopedia, further comprising:
the use of a smart algorithm.

27. The PMSPD of claim 1, wherein the length is not more than 105 mm, the width not more than 61 mm, and the depth not more than 20 mm.
